(19) United States
(12) Patent Application Publication
(10) Pub. No.: US 2009/0300927 A1
(43) Pub. Date: Dec. 10, 2009

(54) TRANSPARENT OVERLAY FOR THE VISUAL ASSESSMENT OF MARKSMANSHIP

(76) Inventors: Miguel Arnoldo Rodriguez, Allen, TX (US); Stephen Michael Waite, Dallas, TX (US)

Correspondence Address: Miguel Arnoldo Rodriguez, 1603 Haven Place, Allen, TX, 75002, US

(21) Appl. No.: 12/134,949

(22) Filed: Jun. 6, 2008

(51) Int. Cl. G01B 5/00

(52) U.S. Cl. 33/1 B

(57) ABSTRACT

One embodiment of the measuring device (5) wherein the measurement pattern is printed on the inside or outside of a transparent medium. Its uses can include being held up between the target and the user, placed directly onto the target or projected onto the target by a light source.

### CROSS-REFERENCE TO RELATED APPLICATIONS

Not Applicable

### FEDERALLY SPONSORED RESEARCH

Not Applicable

### SEQUENCE LISTING OR PROGRAM

Not Applicable

### BACKGROUND OF THE INVENTION

1. Field of Invention

This invention relates to marksmanship in any field where a projectile is launched at a target; specifically, the advancement of accurately assessing shot patterns.

2. Prior Art

Traditionally, methods of measuring marksmanship required the individual to use either a paper measurement printed onto paper or a target comprising of a measurement pattern.

The use of a printed version of the measurement pattern is inaccurate because the person using it must approximate where the pattern would lie on the target. Foreign substances, such as water or oil, also easily damage a paper printout. This causes its usefulness to degrade faster.

The use of targets that implement the measurement pattern can be costly as their use is limited and the target disintegrates after several uses. New targets must be purchased to maintain usefulness. The person using this type of assessment is also limited to using that kind of target.

3. Objects and Advantages
a) This device eliminates the need of costly disposable targets;
b) Eliminates the inaccurate method of visually comparing the measurement to a different target;
c) Allowing the person to use any target for practice and still be able to get an accurate assessment;
d) The implementation of this device can be applied to any projectile target;
e) The device will be waterproof;
f) The device can vary in size;
g) The device is reusable and durable;
h) The device is easily maintained;
i) The device is easy to use;
j) The device can be manufactured using existing manufacturing processes;
k) The device can vary in color to accommodate various lighting conditions;
l) The device can be configured depending on the handedness of the user (left-handed or right handed).

### SUMMARY

This invention, in its current implementation, is comprised of a transparent sheet with the measurement pattern printed upon or within it. It is to be used to accurately assess marksmanship in any field where a projectile is launched at a target.

### DRAWINGS—FIGURES

In the drawings, all figures have been given different numerical designators.

FIG. 1 shows an example of the device.

FIG. 2 shows the device in use between the user and the target at a distance.

FIG. 3 shows the device in use as an overlay directly on the target.

FIG. 4 shows the device in use with a light source projecting the pattern onto a target.

### DRAWINGS—REFERENCE NUMERALS

| | |
|---|---|
| 5 device | 10 observer |
| 15 target | 20 measurement pattern |
| 25 light source | 30 device for use with light source |

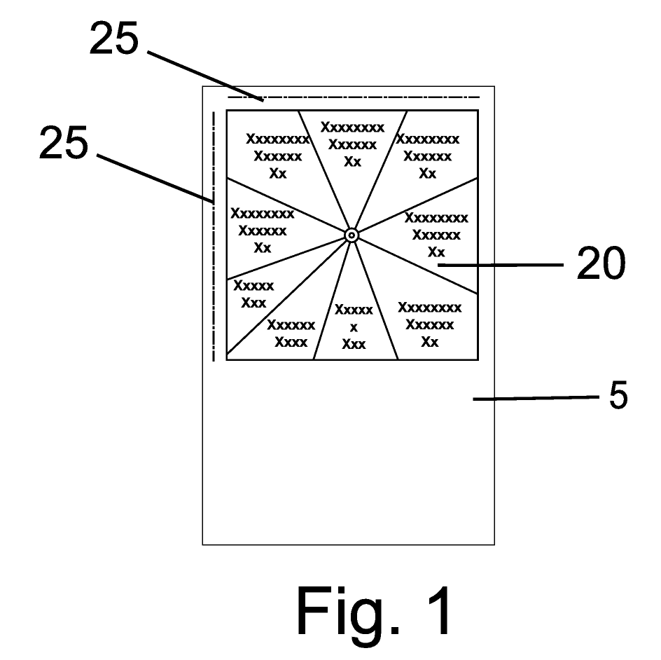

### DETAILED DESCRIPTION—FIG. 1

One embodiment of the device is illustrated in FIG. 1. The device is comprised of a transparent sheet with the measurement pattern printed upon or within it

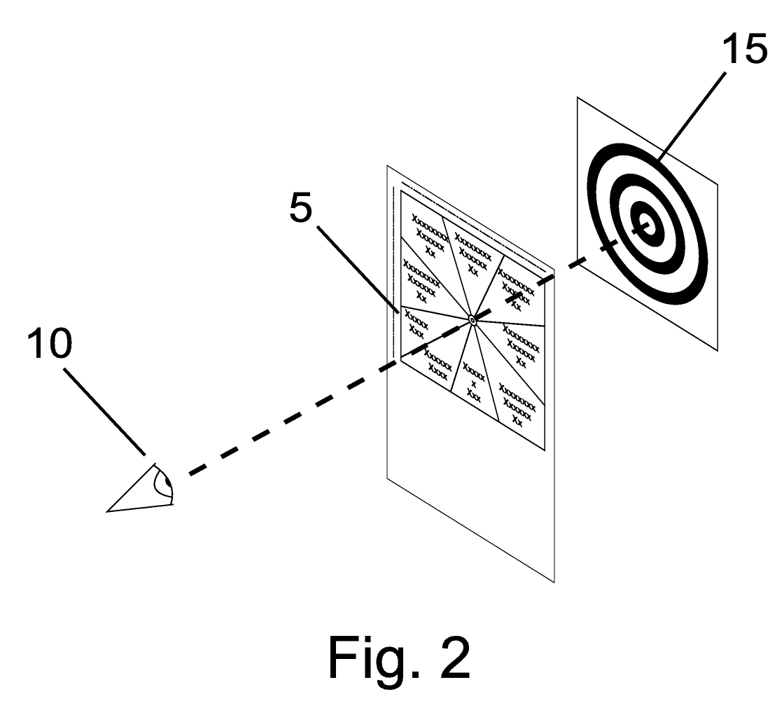

### DETAILED DESCRIPTION—FIG. 2

Illustrated in FIG. 2, the device is held up between the target and the observer, aligning the center of the measurement pattern with the center of the target. This allows the user to visibly verify the cause of any inaccuracies.

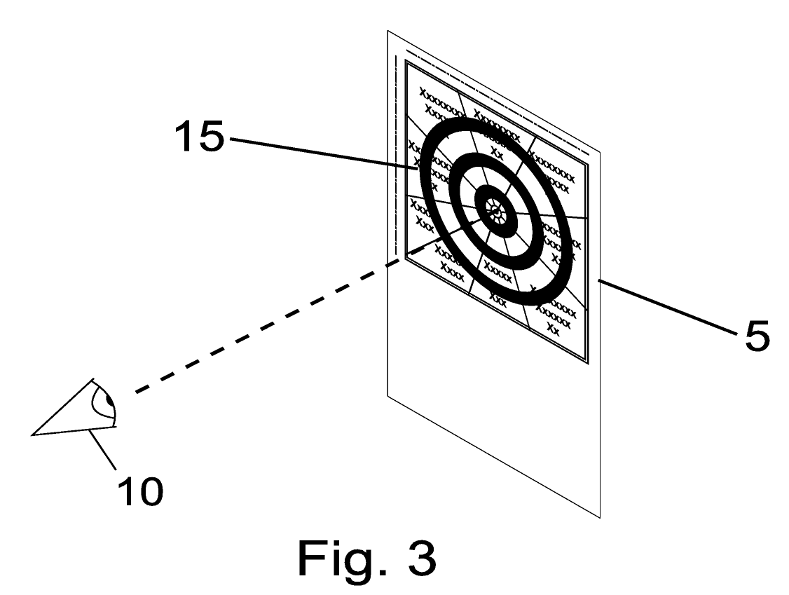

### DETAILED DESCRIPTION—FIG. 3

FIG. 3 demonstrates the method in which the device is held against the target aligning the center of the measurement pattern with the center of the target. This allows for measurements to be taken on targets of any scale.

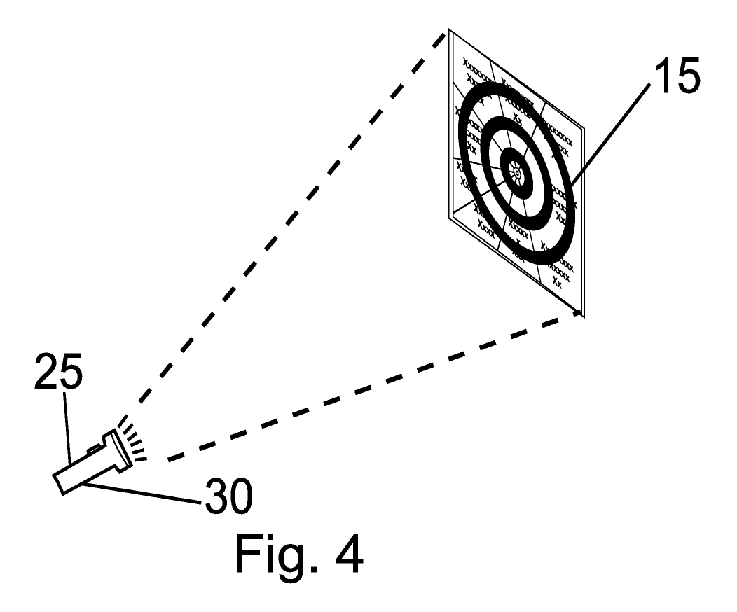

### DETAILED DESCRIPTION—FIG. 4

The method in which a light source is projected through the measurement pattern aligning the center of the measurement pattern with the center of the target is illustrated in FIG. 4. The light can come from any source that puts off enough light to project the pattern on to the target.

We claim:

1. With an overlay for the use of marksmanship assessment comprising of a transparent sheet with the measurement pattern printed upon or within it.

2. The device in claim 1 wherein said body of material is composed of any form of any transparent material, upon which the measurement pattern may be printed.

3. The device in claim 1 wherein said the measurement pattern is printed on the inside or outside.

4. The device in claim 3 wherein said printing can be of different colors, languages, typeface and styles to accommodate different environmental conditions.

5. The device in claim 3 wherein the text directs the user on how to correct their aim.

6. The method use for the measurement device, comprising of:
i. The method in which the device is held up between the target and the user aligning the center of the measurement pattern with the center of the target.
ii. The method in which the device is mounted to a weapon and aligning the center of the measurement pattern with the center of the target.
iii. The method in which the device is held against the target aligning the center of the measurement pattern with the center of the target.
iv. The method in which a light source is projected through the measurement pattern aligning the center of the measurement pattern with the center of the target.
